(19) United States
(12) Patent Application Publication
(10) Pub. No.: US 2015/0134412 A1
(43) Pub. Date: May 14, 2015

(54) TOOLS AND METHODS FOR DIFFERENTIATING CHILD-LIKING SCORES IN PRODUCT TESTING ENVIRONMENTS

(71) Applicant: NESTEC S.A., Vevey (CH)

(72) Inventors: Mary Michele Foley, Whitehall, MI (US); Lotika Savant, Norton Shores, MI (US); Bernard Thomas Carr, Evanston, IL (US)

(21) Appl. No.: 14/381,349

(22) PCT Filed: Feb. 27, 2013
(86) PCT No.: PCT/IB2013/051576

§ 371 Date: Aug. 27, 2014

Related U.S. Application Data
(60) Provisional application No. 61/604,836, filed on Feb. 29, 2012.

(51) Int. Cl. G06Q 30/02

(52) U.S. Cl. CPC G06Q 30/0201
USPC 705/7.31; 705/7.29

(57) ABSTRACT

The present disclosure provides tools and methods for improving differentiation in child-liking scores in a product testing environment and/or to improve development of products for child consumers. In an embodiment, tools for differentiating market research scores are provided and include a product rating scale having a plurality of successive scale points and a verbal anchor corresponding to each scale point, and a behavioral list with a plurality of product acceptance behaviors. Methods for differentiating market research scores are also provided and include instructing a consumer to evaluate a product according to a product rating scale, instructing the consumer to evaluate a product according to a behavioral list, and applying, using a digital computer, a multivariate analysis of variance to the product rating scale information and the behavioral information.

### BACKGROUND

The present disclosure relates generally to health and nutrition. More specifically, the present disclosure relates to methods for improving differentiation in child-liking scores in product testing environments and/or for product development.

Historically, acceptance (e.g., like/dislike) of consumable products by pre-verbal children to guide product development for child-targeted products (e.g., baby food) in a product testing context has been obtained from parents via scale-based responses such as a child-liking scores based on a subjective interpretation of the child's responses to products. Child-liking, as historically assessed by parents, however, is often not very differentiating across multiple products (e.g., mean scores were similar and less significantly different). As a result, decisions to guide product development are often made based solely on adult opinions.

Behavioral observation techniques such as facial coding by expert observers to interpret child-liking during product development testing are also available, but are typically applied in a more academic setting and the results are cumbersome to collect and utilize to guide product development in the fast-paced product testing environment of the consumer goods industry. As such, there exists a need to provide a practical and applicable tool to improve differentiation in child-liking scores in a product testing environment to better aid in development of products for a child consumer. There also exists a need to provide methods for improving differentiation in child-liking scores in a product testing environment.

### SUMMARY

Tools and methods for improving discrimination in child-liking scores for food analysis are provided. In an embodiment, a tool for differentiating market research scores is provided. The tool includes a product rating scale including a plurality of successive scale points and a verbal anchor corresponding to each scale point, and a behavioral list including a plurality of product acceptance behaviors.

In an embodiment, the market research scores are scores related to food products.

In an embodiment, the product rating scale is a food product rating scale.

In an embodiment, the food product is a product developed for administration to a non-verbal child. The food product may also be a product developed for a child of an age ranging from birth to about twelve months.

In an embodiment, the successive scale points comprise integer values.

In an embodiment, the successive scale points range from 1 to 9.

In an embodiment, the product rating scale is a 9-point hedonic scale.

In an embodiment, the verbal anchors describe varying degrees of liking of the product. The verbal anchors may be selected from the group consisting of like extremely, like very much, like moderately, like slightly, neither like nor dislike, dislike slightly, dislike moderately, dislike very much, dislike extremely, or combinations thereof.

In an embodiment, the behavioral list is a check-all-that-apply (“CATA”) list.

In an embodiment, the product acceptance behaviors comprise a plurality of behaviors commonly exhibited during consumption of a food product by children of an age ranging from birth to about twelve months. Examples of product acceptance behaviors include, but are not limited to, turned/pushed food away, spit food out, shudder, shook head “no,” looked at food administrator with surprise, wrinkled nose, frowned, communicated dislike, would not eat more without encouragement, showed enthusiasm/excitement, nodded “yes,” communicated liking, ate easily/quickly, seemed to want more, leaned toward food, looked at food administrator with happy surprise, other, none, or combinations thereof. In an embodiment, the product acceptance behaviors are selected from the group consisting of turned/pushed food away, would not eat more without encouragement, showed enthusiasm/excitement, ate easily/quickly, seemed to want more, leaned toward food, or combinations thereof.

In an embodiment, the tools further include a computer and a non-transitory computer-readable medium accessible to the computer and containing a software program therein, wherein the software program is programmed to cause a computer processor to run a multivariate analysis of variance.

In another embodiment, a tool for improving product development is provided. The tool includes a 9-point hedonic scale including a plurality of successive scale points ranging from 1 to 9, and a verbal anchor corresponding to each scale point, and a check-all-that-apply behavior checklist including product acceptance behaviors selected from the group consisting of turned/pushed food away, spit food out, shudder, shook head “no,” looked at food administrator with surprise, wrinkled nose, frowned, communicated dislike, would not eat more without encouragement, showed enthusiasm/excitement, nodded “yes,” communicated liking, ate easily/quickly, seemed to want more, leaned toward food, looked at food administrator with happy surprise, other, none, or combinations thereof.

In yet another embodiment, a tool for increasing separation of market research scores between at least two products is provided. The tool includes a product rating scale for a first product, the scale including a plurality of successive scale points and a verbal anchor corresponding to each scale point, a product rating scale for a second product, the scale including a plurality of successive scale points and a verbal anchor corresponding to each scale point, a behavioral list comprising a plurality of product acceptance behaviors for a first product, and a behavioral list comprising a plurality of product acceptance behaviors for a second product.

In an embodiment, the product rating scale for the first product is the same as the product rating scale for the second product.

In an embodiment, the behavioral list for the first product is the same as the behavioral list for the second product.

In still yet another embodiment, a kit for differentiating market research scores is provided. The kit includes a product rating scale including a plurality of successive scale points and a verbal anchor corresponding to each scale point, and a behavioral list including a plurality of product acceptance behaviors.

In another embodiment, a method for differentiating market research scores is provided. The method includes providing a product rating scale including a plurality of successive scale points and a verbal anchor corresponding to each scale point, providing a behavioral list including a plurality of product acceptance behaviors, instructing a consumer to evaluate a product according to the product rating scale to obtain product rating scale information, instructing the consumer to evaluate a product according to the behavioral list to obtain behavioral information, and applying, using a digital computer, a multivariate analysis of variance to the product rating scale information and the behavioral information.

In an embodiment, the consumer is an adult. The step of instructing the consumer to evaluate the product according to the product rating scale may include instructing the adult to taste the product.

In an embodiment, the consumer is a pre-verbal child. The step of instructing the consumer to evaluate the product according to the product rating scale may include instructing an adult to administer the product to the pre-verbal child and to assess child-liking based on the product rating scale. The step of instructing the consumer to evaluate a product according to the behavioral list may also include instructing an adult to administer the product to the pre-verbal child and to note any product acceptance behaviors exhibited by the child.

In an embodiment, the behavioral information comprises one or more indicated product acceptance behaviors.

In an embodiment, the indicated product acceptance behaviors are product acceptance behaviors exhibited by a pre-verbal child upon tasting the product.

In yet another embodiment, a method for improving product development is provided. The method includes instructing a consumer to evaluate a product with a 9-point hedonic scale including a plurality of successive scale points ranging from 1 to 9, and a verbal anchor corresponding to each scale point, and instructing the consumer to evaluate the product with a check-all-that-apply behavior checklist including product acceptance behaviors selected from the group consisting of turned/pushed food away, spit food out, shudder, shook head “no,” looked at food administrator with surprise, wrinkled nose, frowned, communicated dislike, would not eat more without encouragement, showed enthusiasm/excitement, nodded “yes,” communicated liking, ate easily/quickly, seemed to want more, leaned toward food, looked at food administrator with happy surprise, other, none, or combinations thereof, and applying, using a digital computer, a multivariate analysis of variance to product rating scale information and the behavioral information obtained from the product evaluations.

In still yet another embodiment, a method for improving product development is provided. The method includes providing a product rating scale including a plurality of successive scale points and a verbal anchor corresponding to each scale point, providing a behavioral list including a plurality of product acceptance behaviors, instructing a consumer to evaluate a product according to the product rating scale and the behavioral list to obtain product rating scale information and behavioral information, applying, using a digital computer, a multivariate analysis of variance to the product rating scale information and the behavioral information, and adjusting characteristics of the product based on results of the multivariate analysis of variance.

In another embodiment, a method for developing a new consumable product is provided. The method includes providing a product rating scale including a plurality of successive scale points and a verbal anchor corresponding to each scale point, providing a behavioral list including a plurality of product acceptance behaviors, instructing a consumer to evaluate an existing consumable product according to the product rating scale and the behavioral list to obtain product rating scale information and behavioral information, applying, using a digital computer, a multivariate analysis of variance to the product rating scale information and the behavioral information, and adjusting characteristics of the existing product based on results of the multivariate analysis of variance to obtain a new consumable product.

In yet another embodiment, a method for improving marketing of a consumable product is provided. The method includes providing a product rating scale comprising a plurality of successive scale points and a verbal anchor corresponding to each scale point, providing a behavioral list comprising a plurality of product acceptance behaviors, instructing a consumer to evaluate a product according to the product rating scale and the behavioral list to obtain product rating scale information and behavioral information, applying, using a digital computer, a multivariate analysis of variance to the product rating scale information and the behavioral information, and adjusting a marketing strategy based on results of the multivariate analysis of variance.

In still yet another embodiment, a method for predicting market success of a product is provided. The method includes providing a product rating scale comprising a plurality of successive scale points and a verbal anchor corresponding to each scale point, providing a behavioral list comprising a plurality of product acceptance behaviors, instructing a consumer to evaluate a product according to the product rating scale and the behavioral list to obtain product rating scale information and behavioral information, applying, using a digital computer, a multivariate analysis of variance to the product rating scale information and the behavioral information, and predicting the market success of the product based on the multivariate analysis of variance analysis.

An advantage of the present disclosure is to provide tools and methods for improving discrimination in child-liking scores in a product testing environment.

Another advantage of the present disclosure is to provide tools and methods for improving product development.

Yet another advantage of the present disclosure is to provide tools and method for differentiating child-liking scores in a product testing environment.

Still yet another advantage of the present disclosure is to provide methods for determining key product acceptance behaviors exhibited by children during product testing.

Another advantage of the present disclosure is to provide tools and methods for monitoring child acceptance of a food product.

Yet another advantage is to provide tools and methods for discriminating child-liking across multiple food products for children.

Still yet another advantage is to provide tools for predicting the marketing success of a food product.

Additional features and advantages are described herein, and will be apparent from the following Detailed Description.

### DETAILED DESCRIPTION

As used herein, a “9-Point Hedonic Scale” refers to the 9-Point Hedonic Scale developed by David Peryam and colleagues at the Quartermaster Food and Container Institute of the U.S. Armed Forces. The 9-Point Hedonic Scale includes successive integer values ranging from 1 to 9, each integer value being associated with a verbal anchor that is different from every other verbal anchor. The 9-Point Hedonic Scale includes the following integers and verbal anchors: 1—Dislike Extremely; 2—Dislike Very Much; 3—Dislike Moderately; 4—Dislike Slightly; 5—Neither Like Nor Dislike; 6—Like Slightly; 7—Like Moderately; 8—Like Very Much; and 9—Like Extremely.

As used in this disclosure and the appended claims, the singular forms “a,” “an” and “the” include plural referents unless the context clearly dictates otherwise.

As used herein, “about” is understood to refer to numbers in a range of numerals. Moreover, all numerical ranges herein should be understood to include all integer, whole or fractions, within the range.

As used herein, “adult-liking” refers to an adult's liking or disliking of a consumable product according to a product rating scale such as, for example, the 9-Point Hedonic Scale. For example, if an adult finds a consumable product to be delicious, the adult may indicate a liking of the product as Like Extremely (e.g., scale rating of a 9), or Like Very Much (e.g., scale rating of 8). The skilled artisan will appreciate, however, that adult-liking need not be measured only by the 9-Point Hedonic Scale and may be measured using any rating scale known in the art.

As used herein, a “behavioral list” or a “behavioral checklist” refers to a list of product acceptance behaviors that may be exhibited by children upon tasting or consumption of a food product.

As used herein, a “check-all-that-apply” list or checklist, or a “CATA” list or checklist refers to a list of common items that are intended to be marked (e.g., circled, starred, checked, underlined, etc.) by a consumer/evaluator, for example, during a product evaluation.

As used herein, “child-liking” refers to a child's liking or disliking of a consumable product according to a product rating scale such as, for example, the 9-Point Hedonic Scale. Child-liking is commonly interpreted by parents and/or trained evaluators after administration of a consumable product to the child and after the child exhibits a product acceptance behavior. For example, if a child turns away from food, or pushes food away, the product acceptance behavior is strongly associated with dislike of the food and the parent may interpret the child's liking as Dislike Extremely (e.g., scale rating of a 1), or Dislike Very Much (e.g., scale rating of 2). The skilled artisan will appreciate, however, that child-liking need not be measured only by the 9-Point Hedonic Scale and may be measured using any rating scale known in the art.

As used herein, “key product acceptance behaviors” refer to product acceptance behaviors that have been found to have a significant impact on distinguishing child-liking scores between different food products. In other words, key product acceptance behaviors provide more information about child-liking of a food product than other product acceptance behaviors. Key product acceptance behaviors may be identified, for example, through experimental research wherein the most commonly used product acceptance behaviors are identified as key product acceptance behaviors. Examples of key product acceptance behaviors include, for example, showed enthusiasm/excitement, ate easily/quickly, seemed to want more, leaned toward food, would not heat more without encouragement, turned/pushed away, etc.

As used herein, “multivariate analysis of variance” or “MANOVA” refers to the statistical test procedure for comparing multivariate (population) means of at least two groups (e.g., at least two different dependent variables). MANOVA uses the variance-covariance between variables in testing the statistical significance of the mean differences. The skilled artisan would immediately understand what is meant by multivariate analysis of variance, or MANOVA, would understand how to use such statistical analysis, and would understand how to analyze and interpret results obtained by such analysis.

As used herein, “product acceptance behaviors” refer to behaviors exhibited by children upon tasting or consumption of a food product. Such behaviors may include, for example, turned/pushed food away, spit food out, shuddered, shook head “no,” looked at product administrator with surprise (“yuk”), wrinkled nose, frowned, communicated dislike (said “yuk” or “no”), would not eat more without encouragement, showed enthusiasm/excitement, nodded “yes,” communicated liking (said “yum” or “yes”), ate easily/quickly, seemed to want more, leaned toward food, looked at product administrator with happy surprise (“yum”), other, none, etc.

As used herein, a “verbal anchor” refers to a phrase that is descriptive of a degree of a product liking or disliking and may or may not correspond to a numerical scale rating. For example, with the 9-Point Hedonic Scale, verbal anchors include, for example, Like Extremely, Like Very Much, Like Moderately, Like Slightly, Neither Like nor Dislike, Dislike Slightly, Dislike Moderately, Dislike Very Much, Dislike Extremely, etc. Further, in the 9-Point Hedonic Scale, the verbal anchor “Like Extremely” corresponds to a numerical scale rating of 9, the verbal anchor “Like Very Much” corresponds to a numerical scale rating of 8, and so on.

Because the market for children's foods is continuously growing and expanding, and because children have an increasing influence on food purchase decisions, children are increasingly being used in product development by food manufacturers. Child-liking of a product is critical for success of the product on the market. Indeed, a baby is much more likely to adopt a food if it is well-liked and administered repeatedly. Thus, it is important for companies providing foods for pre-verbal children to understand their needs and wants with respect to foods.

These age groups, however, present a challenge with respect to sensory and consumer research testing because of their inability to communicate verbally. Taste and olfactory responses of newborns and infants have previously been assessed by studying hedonically-motivated characteristics such as, for example, facial expressions, respiration, heart rate, sucking patterns, differential ingestion, and autonomic reactivity. The responses may also be measured by studying, for example, lateral tongue movements.

One example of a method to test acceptance (e.g., like/dislike) of consumable products by pre-verbal children to guide product development for child targeted products (e.g., baby food) in a product testing context includes the use of scale-based responses such as a child-liking scores based on a subjective interpretation of the child's responses to products. These types of testing methods, which are typically implemented by parents, have been used almost exclusively in the past because pre-verbal children cannot read, write, or use words to described their liking or disliking of particular food product. In contrast, parents must rely on the facial and bodily expression of such children to determine the liking and/or wanting of a specific food product. Child-liking, as historically assessed by parents, therefore, is often not very differentiating across multiple products (e.g., mean scores were similar and less significantly different). As a result, decisions to guide product development are often made based solely on adult opinions.

The 9-Point Hedonic Scale developed by David Peryam and colleagues is one example of such a scale-based approach and was quickly adopted by the food, personal care, household products and cosmetic industries. The 9-Point Hedonic Scale includes verbal anchors that were selected so that the psychological distance between successive scale points is approximately equal. The equal-interval property helps to justify the practice of analyzing the responses by assigning successive integer values to the scale points and testing differences in average acceptability using parametric statistics.

The verbal anchors associated with the 9-Point Hedonic Scale include Like Extremely, Like Very Much, Like Moderately, Like Slightly, Neither Like nor Dislike, Dislike Slightly, Dislike Moderately, Dislike Very Much, and Dislike Extremely. The integer values assigned to each of these verbal anchors range from 9 down to 1, respectively. The 9-Point Hedonic Scale is set forth below at Table 1.

TABLE 1
9-Point Hedonic Scale

| | |
|---|---|
| 9 | Like Extremely |
| 8 | Like Very Much |
| 7 | Like Moderately |
| 6 | Like Slightly |
| 5 | Neither Like nor Dislike |
| 4 | Dislike Slightly |
| 3 | Dislike Moderately |
| 2 | Dislike Very Much |
| 1 | Dislike Extremely |

One scale-based extension of the 9-Point Hedonic Scale was developed, in part, by B. J. Kroll in 1990 and showed that a scale with nine “child friendly” verbal anchors ranging from “super good” to “super bad” performed better with 5-10 year old children than did the 9-Point Hedonic Scale or a scale utilizing “smiley” faces. Such a scale, however, is not as reliable as the 9-Point Hedonic Scale when dealing with children younger than this age group.

Additionally, behavioral observation techniques such as facial coding by expert observers to interpret child-liking during product development testing are also available for use. These techniques, however, are typically applied in a more academic setting and the results are cumbersome to collect and utilize to guide product development in the fast-paced product testing environment of the consumer goods industry.

In response to such inefficient or cumbersome product development testing models, Applicant has created a practically applicable tool to improve differentiation in child-liking scores in a product testing environment to better aid in development of products to delight the child consumer. Indeed, Applicants has developed tools and methods to help understand the drivers of child-liking scores, assess the effectiveness of parental interpretation by relating liking/wanting behaviors of child-liking scores, and to identify strategies to improve differentiation in child-liking without increasing sample size.

Generally speaking, Applicant has determined key child behaviors that improve discrimination in child-liking and applied a Multivariate Analysis of Variance (“MANOVA”) to the behaviors along with child-liking scores to create a tool to increase the ‘power’ of the means separation procedure. The tool yields improved discrimination across multiple products for children, and especially pre-verbal children aged four to twelve months. The tool can be applied across multiple products and/or prototypes to compare relative child acceptance.

In an embodiment, the tools of the present disclosure include the use of a scale-based approach in combination with a behavioral checklist. The scale-based approach may include a numerical ranking score that is associated with specific verbal anchors. An example of such a scale-based approach includes the 9-Point Hedonic Scale. The skilled artisan will appreciate, however, that the 9-Point Hedonic Scale is not the only scale that may be used and other similar scales known to the skilled artisan may be used. Applicant has found, however, that the use of a scale-based approach alone does not always provide enough information for separation of data across several different food product samples. For example, the use of a scale-based approach alone may indicate that a child preferred all tested food products equally when, in fact, the child prefers one or two samples more than the remaining samples.

Because of the deficiencies and lack of discrimination of child-liking scores found when using the scale-based approach alone, Applicant has paired the scale-based approach with a behavioral checklist to obtain more differentiation amongst child-liking scores. With respect to the behavioral checklist, Applicant has taken child acceptance behavioral cues from prior behavioral research to develop a list of product acceptance behaviors. Examples of product acceptance behaviors commonly exhibited by children during or just after taste or consumption of a food product include, for example, turned/pushed food away, spit food out, shuddered, shook head “no,” looked at product administrator with surprise (“yuk”), wrinkled nose, frowned, communicated dislike (said “yuk” or “no”), would not eat more without encouragement, showed enthusiasm/excitement, nodded “yes,” communicated liking (said “yum” or “yes”), ate easily/quickly, seemed to want more, leaned toward food, looked at product administrator with happy surprise (“yum”), other, none, etc. An example of a behavioral checklist is set forth below at Table 2.

TABLE 2
Behavioral Checklist
CHECK ALL THAT APPLY

Turned/Pushed Away
Spit Food Out
Shudder
Shook Head “No”
Looked At You With Surprise (“Yuk”)
Wrinkled Nose
Frowned
Communicated Dislike (said “Yuk”/“No”)
Would Not Eat More Without Encouragement
Showed Enthusiasm/Excitement
Nodded “Yes”
Communicated Liking (said “Yum”/“Yes”)
Ate Easily/Quickly
Seemed To Want More
Leaned Toward Food
Looked At You With Happy Surprise (“Yum”)
Other: Please Specify
None

As an indicator of child-liking of a food product, these behaviors are usually identified by parents, who may serve as administrators of the test food products, and who are most familiar with their child's behaviors, expressions, etc. The inclusion of a list or checklist of product acceptance behaviors established to be positively or negatively associated with a child's liking allows parents to provide an objective report of behaviors displayed during product trials in addition to the quantitative data obtained using a scale-based approach.

Applicant has also found that certain product acceptance behaviors provide more information (e.g., are displayed more frequently) about product testing than others. Accordingly, the product acceptance behaviors listed above may be refined to a subset of key product acceptance behaviors that can be incorporated into product testing in a shorter checklist format suitable for evaluation by parents. For example, key product acceptance behaviors may include, for example, showed enthusiasm/excitement, ate easily/quickly, seemed to want more, leaned toward food, would not heat more without encouragement, turned/pushed away, etc. The skilled artisan will appreciate, however, that this list is not exhaustive and the list may include any other commonly exhibited product acceptance behaviors. An example of a key behavioral checklist is set forth below at Table 3.

TABLE 3
Behavioral Checklist
CHECK ALL THAT APPLY

Turned/Pushed Away
Would Not Eat More Without Encouragement
Showed Enthusiasm/Excitement
Ate Easily/Quickly
Seemed To Want More
Leaned Toward Food

Accordingly, the presently claimed tools and methods include administration of a scale-based approach, as well as a behavior checklist. Administration of the scale-based approach (e.g., 9-Point Hedonic Scale) may include gathering adult-liking scores as well as child-liking scores, which can collectively or individually be known as scale-based information or results. For example, an adult may sample the food products and provide numerical values based on the adult's liking or disliking of the product. Alternatively, an adult (e.g., parent, test administrator, behavioral expert, etc.) may administer the food product to a child, interpret the child's liking or disliking, and provide a numerical value that corresponds to the verbal anchor associated with the interpreted liking or disliking.

Applicant has found that the addition of a behavioral checklist to the scale-based approach is more efficient than using behavioral coding approaches and is more discriminating when compared to the use of scale-based approaches alone. When utilizing a behavioral checklist for product testing with children, parents or test administrators generally provide the food product to the child and identify any product acceptance behaviors exhibited by the child in reaction to the taste, texture, etc. of the food product. The parent can then mark each of the exhibited behaviors on the behavioral checklist. The behavioral information obtained by using a behavioral checklist, therefore, is a list of every exhibited product acceptance behavior by the child in response to the food product.

In order to synthesize the scale-based information with the behavioral information obtained during product testing, a multivariate analysis can be performed. Specifically, a multivariate analysis of variance may be used to combine “subjective” parent-interpreted child-liking data (i.e., scale/rating data) with the “objective” record of child product acceptance behaviors displayed (i.e., count data, or percentages) during product evaluation to create a more differentiating tool to assess child product acceptance and to articulate the voice of the pre-verbal child who is ultimately the target consumer. In another embodiment, however, the tools of the present disclosure could also be applied to situations where improved discrimination is desired, for example, to overcome constraints from literacy limitations, language barriers, scaling issues, etc.

A multivariate analysis of variance (“MANOVA”) is a statistical test procedure for comparing multivariate (population) means of at least two different groups (e.g., scale-based information and behavioral information). The skilled artisan would immediately understand how to perform a MANOVA. For example, a MANOVA may be performed using a computer running appropriate software that is programmed to cause a computer processor to execute a MANOVA using the collected scale-based information and behavioral information. In such an embodiment, the tools of the present disclosure may include a computer and a non-transitory computer-readable medium accessible to the computer and containing a software program therein. The software program may be programmed to cause a computer processor to run a multivariate analysis of variance using the collected information from product testing.

In another embodiment, a kit for differentiating market research scores is provided. The kit includes a product rating scale including a plurality of successive scale points and a verbal anchor corresponding to each scale point, and a behavioral list including a plurality of product acceptance behaviors.

Methods for using the tools of the present disclosure are also provided herein. In an embodiment, a method for differentiating market research scores is provided. The method includes providing a product rating scale including a plurality of successive scale points and a verbal anchor corresponding to each scale point, providing a behavioral list including a plurality of product acceptance behaviors, instructing a consumer to evaluate a product according to the product rating scale to obtain product rating scale information, instructing the consumer to evaluate a product according to the behavioral list to obtain behavioral information, and applying, using a digital computer, a multivariate analysis of variance to the product rating scale information and the behavioral information.

The consumer may be, for example, an adult or a pre-verbal child. Where the consumer is an adult, the step of instructing the consumer to evaluate the product according to the product rating scale may include instructing the adult to taste the product. Where the consumer is a pre-verbal child, the step of instructing the consumer to evaluate the product according to the product rating scale may include instructing an adult to administer the product to the pre-verbal child and to assess child-liking based on the product rating scale. Where the consumer is a pre-verbal child, the step of instructing the consumer to evaluate a product according to the behavioral list may also include instructing an adult to administer the product to the pre-verbal child and to note any product acceptance behaviors exhibited by the child.

The behavioral information may include one or more indicated product acceptance behaviors. The indicated product acceptance behaviors may be product acceptance behaviors exhibited by a pre-verbal child upon tasting the product.

In yet another embodiment, a method for improving product development is provided. The method includes instructing a consumer to evaluate a product with a 9-point hedonic scale including a plurality of successive scale points ranging from 1 to 9, and a verbal anchor corresponding to each scale point, and instructing the consumer to evaluate the product with a check-all-that-apply behavior checklist including product acceptance behaviors selected from the group consisting of turned/pushed food away, spit food out, shudder, shook head “no,” looked at food administrator with surprise, wrinkled nose, frowned, communicated dislike, would not eat more without encouragement, showed enthusiasm/excitement, nodded “yes,” communicated liking, ate easily/quickly, seemed to want more, leaned toward food, looked at food administrator with happy surprise, other, none, or combinations thereof, and applying, using a digital computer, a multivariate analysis of variance to product rating scale information and the behavioral information obtained from the product evaluations.

In still yet another embodiment, a method for improving product development is provided. The method includes providing a product rating scale including a plurality of successive scale points and a verbal anchor corresponding to each scale point, providing a behavioral list including a plurality of product acceptance behaviors, instructing a consumer to evaluate a product according to the product rating scale and the behavioral list to obtain product rating scale information and behavioral information, applying, using a digital computer, a multivariate analysis of variance to the product rating scale information and the behavioral information, and adjusting characteristics of the product based on results of the multivariate analysis of variance.

In this regard, a product prototype may be developed and subject to consumer research including parents and/or children. Upon collection of consumer research data, it may be found that consumers prefer or dislike certain aspects of the developed prototype. In response, therefore, it is possible to adjust those characteristics of the product to improve the liking and/or acceptance of the product.

In another embodiment, a method for developing a new consumable product is provided. The method includes providing a product rating scale including a plurality of successive scale points and a verbal anchor corresponding to each scale point, providing a behavioral list including a plurality of product acceptance behaviors, instructing a consumer to evaluate an existing consumable product according to the product rating scale and the behavioral list to obtain product rating scale information and behavioral information, applying, using a digital computer, a multivariate analysis of variance to the product rating scale information and the behavioral information, and adjusting characteristics of the existing product based on results of the multivariate analysis of variance to obtain a new consumable product.

In this regard, a product prototype may be developed and subject to consumer research including parents and/or children. Upon collection of consumer research data, it may be found that consumers prefer or dislike certain aspects of the developed prototype. In response, therefore, it is possible to adjust those characteristics of the product to obtain a new consumable product.

In yet another embodiment, a method for improving marketing of a consumable product is provided. The method includes providing a product rating scale comprising a plurality of successive scale points and a verbal anchor corresponding to each scale point, providing a behavioral list comprising a plurality of product acceptance behaviors, instructing a consumer to evaluate a product according to the product rating scale and the behavioral list to obtain product rating scale information and behavioral information, applying, using a digital computer, a multivariate analysis of variance to the product rating scale information and the behavioral information, and adjusting a marketing strategy based on results of the multivariate analysis of variance.

In this regard, a product prototype may be developed and subject to consumer research including parents and/or children. Upon collection of consumer research data, it may be found that consumers prefer or dislike certain marketing aspects of the prototype. In response, therefore, it is possible to adjust those characteristics of the marketing strategy to improve the liking and/or acceptance of the product. For example, it may be possible to adjust or change a slogan, branding information, packaging aesthetics (color, size, shape, etc.), target audience, etc.

In yet another embodiment, a method for predicting market success of a food product is provided. The method includes providing a product rating scale comprising a plurality of successive scale points and a verbal anchor corresponding to each scale point, providing a behavioral list comprising a plurality of product acceptance behaviors, instructing a consumer to evaluate a product according to the product rating scale and the behavioral list to obtain product rating scale information and behavioral information, applying, using a digital computer, a multivariate analysis of variance to the product rating scale information and the behavioral information, and predicting the market success of the product based on the multivariate analysis of variance analysis.

The predicting step is described further below with respect to the examples. Generally speaking, however, the predicting step may include determining a maximum result of the multivariate analysis of variance with respect to any positive product acceptance behaviors and determining a minimum result of the multivariate analysis of variance with respect to any negative product acceptance behaviors. In this regard, a MANOVA analysis of product scale rating information and behavioral information generally returns a plurality of values that may or may not be combined with a letter indicator to indicate significance in the data. To predict which of the tested products are best accepted, or highest rated, by a consumer during testing, the MANOVA results with respect to any positive product acceptance behaviors should be maximized and the MANOVA results with respect to any negative product acceptance behaviors should be minimized. Generally speaking, the product with the highest positive product acceptance scores (after MANOVA) and the lowest negative product acceptance scores (after MANOVA) will be the best accepted, or highest ranking, consumer product tested. Such a product, accordingly, would be predicted to have the best success in the market when compared to the other tested products. Conversely, the product with the lowest positive product acceptance scores (after MANOVA) and the highest negative product acceptance scores (after MANOVA) will be the least accepted, or lowest ranking, consumer product tested. Such a product, accordingly, would be predicted to have the least amount of success in the market when compared to the other tested products.

By way of example and not limitation, the following examples are illustrative of various embodiments of the present disclosure.

### Example 1

### Deficiencies of Product Testing Using Only a Scale-Based Approach

To demonstrate the lack of discrimination of Liking scores using only a scale-based approach, Applicant performed food product tests with a sample group of 79 parents and 79 six to thirteen month old children. Applicant performed the tests using three different yogurts with grain products and a similar competitor yogurt product.

As shown in Table 4, when Applicant used a scale-based approach to obtain adult-liking and child-liking data, all samples were at parity for both adult-liking and child-liking. Indeed, no significant differences existed at the 90% confidence level (p=0.10=10% confidence level). Applicant used a “p” value of less than 0.1 to indicate whether significance in the data was achieved. Accordingly, “p” values of equal to or greater than 0.1 indicated no significance.

TABLE 4

| | Apple | Apple | Apple | Competitor |
|---|---|---|---|---|
| | Cinnamon | Cinnamon | Cinnamon | Apple |
| | Yogurt with | Yogurt with | Yogurt with | Yogurt |
| | Grains | Whole Grains | Multigrains | Product |
| Child-Liking | 7.5 | 7.3 | 7.5 | 7.3 |
| Adult-Liking | 7 | 6.8 | 7 | 6.7 |

Improved Discrimination of Product Testing Scores Using Tools of the Present Disclosure

To improve discrimination of the child-liking scores obtained using the scale-based approach above, Applicant provided a key behavioral checklist similar to the key behavioral checklist set forth in Table 3 above to the parents involved in the product testing. The parents administered the four food products to the children, identified which of the key product acceptance behaviors were exhibited by the children and marked the exhibited behaviors on the checklist.

To synthesize results of the scale-based information with the behavioral information, a MANOVA was performed. The MANOVA results help to indicate significance in the data or no significance in the data, and help to discriminate the child-liking scores. The MANOVA results use significance “tiers” to indicate the level of significance achieved with a specific evaluation. The “A” tier represents the highest level of significance; the “B” tier indicates the next highest level of significant difference after “A,” the “C” tier indicates the next highest level of significant difference after the “B” tier, etc. The results of the MANOVA analysis are set forth below at Table 5.

TABLE 5

| | Apple Cinnamon | Apple Cinnamon | Apple Cinnamon | |
|---|---|---|---|---|
| | Yogurt with | Yogurt with | Yogurt with | Competitor Apple |
| | Grains | Whole Grains | Multigrains | Yogurt Product |
| Child-Liking | 7.5 | 7.3 | 7.5 | 7.3 |
| Maximize: | | | | |
| Enthusiasm | 38 | 33 | 38 | 27 |
| Ate Easily/Quickly | 71B | 100A | 94A | 68B |
| Seemed to Want More | 58 | 54 | 67 | 66 |
| Leaned Toward Food | 49 | 47 | 51 | 49 |
| Minimize: | | | | |
| Turned/Pushed Away | 3 | 0 | 0 | 1 |
| Would Not Eat Without | 5AB | 10B | 3A | 1A |
| Encouragement | | | | |

To interpret the MANOVA values, Applicant evaluated the results to obtain the highest scores for positive child-liking behaviors and the lowest scores for negative child-liking behaviors. For example, with the “maximize” behavior of enthusiasm, the Apple Cinnamon Yogurt with Grain and the Apple Cinnamon Yogurt with Multigrain scored the highest. For the “maximize” behavior of Ate Easily/Quickly, the Apple Cinnamon Yogurt with Whole Grains scored the highest. For the “maximize” behavior of Seemed to Want More, the Apple Cinnamon Yogurt with Multigrain scored the highest. For the “maximize” behavior of Leaned Toward Food, the Apple Cinnamon Yogurt with Multigrain scored the highest. Therefore, the Apple Cinnamon Yogurt with Multigrain clearly scored the highest amongst the behaviors to maximize.

Alternatively, for the “minimize” behavior of Turned/Pushed Away, the Apple Cinnamon Yogurt with Whole Grains and the Apple Cinnamon Yogurt with Multigrain scored the lowest. For the “minimize” behavior of Would Not Eat Without Encouragement, the Competitor Product scored the lowest. Therefore, the Apple Cinnamon Yogurt with Whole Grains, Apple Cinnamon Yogurt with Multigrain, and Competitor products scored the lowest amongst the behaviors to minimize Since the Apple Cinnamon Yogurt with Multigrains clearly scored the highest amongst the behaviors to maximize and the lowest amongst the behaviors to minimize, it is clear that the Apple Cinnamon Yogurt with Multigrain were preferred by the children to all three other samples.

As such, using the tools of the present disclosure (i.e., a scale-based approach in combination with a behavioral checklist), Applicant was able to improve discrimination of child-liking scores of specific food products being tested. In view of the improved discrimination, the tools of the present disclosure will improve the efficiency and effectiveness of product testing, and will provide for improved product development as a result.

### Example 2

### Deficiencies of Product Testing Using Only a Scale-Based Approach

To demonstrate the lack of discrimination of Liking scores using only a scale-based approach, Applicant performed food product tests with a sample group of 90 parents and 90 eight to fifteen month old children. Applicant performed the tests using four different sweet potato formulations.

As shown in Table 6, when Applicant used a scale-based approach to obtain adult-liking and child-liking data, all samples were at parity for both adult-liking and child-liking. Indeed, no significant differences existed at the 90% confidence level (p=0.10=10% confidence level). Applicant used a “p” value of less than 0.1 to indicate whether significance in the data was achieved. Accordingly, “p” values of equal to or greater than 0.1 indicated no significance.

TABLE 6

| | | | | Sweet |
|---|---|---|---|---|
| | | | | Potatoes |
| | | | | with |
| | | | | Brand |
| | Sweet Potatoes | Sweet Potatoes | Sweet Potatoes | #3 |
| | with Brand #1 | with Brand #1 | with Brand #2 | Carrot |
| | Apple Powder | Carrot Powder | Carrot Powder | Powder |
| Child-Liking | 7 | 6.9 | 7.1 | 6.9 |
| Adult-Liking | 6.4 | 6.5 | 6.7 | 6.4 |

Improved Discrimination of Product Testing Scores Using Tools of the Present Disclosure

To improve discrimination of the child-liking scores obtained using the scale-based approach above, Applicant provided a key behavioral checklist similar to the key behavioral checklist set forth in Table 3 above to the parents involved in the product testing. The parents administered the four food products to the children, identified which of the key product acceptance behaviors were exhibited by the children and marked the exhibited behaviors on the checklist.

To synthesize results of the scale-based information with the behavioral information, a MANOVA was performed. The MANOVA results help to indicate significance in the data or no significance in the data, and help to discriminate the child-liking scores. The MANOVA results use significance “tiers” to indicate the level of significance achieved with a specific evaluation. The “A” tier represents the highest level of significance; the “B” tier indicates the next highest level of significant difference after “A,” the “C” tier indicates the next highest level of significant difference after the “B” tier, etc. The results of the MANOVA analysis are set forth below at Table 7.

TABLE 7

| | Sweet Potatoes | Sweet Potatoes | Sweet Potatoes | Sweet Potatoes |
|---|---|---|---|---|
| | with Brand #1 | with Brand #1 | with Brand #2 | with Brand #3 |
| | Apple Powder | Carrot Powder | Carrot Powder | Carrot Powder |
| Child-Liking | 7 | 6.9 | 7.1 | 6.9 |
| Maximize: | | | | |
| Enthusiasm | 30B | 37A | 36A | 36A |
| Ate Easily/Quickly | 59B | 66A | 62AB | 66A |
| Seemed to Want More | 56AB | 61A | 53B | 60A |
| Leaned Toward Food | 34 | 36 | 39 | 40 |
| Minimize: | | | | |
| Turned/Pushed Away | 10B | 11B | 6A | 16C |
| Would Not Eat Without | 16 | 13 | 9 | 12 |
| Encouragement | | | | |

To interpret the MANOVA values, Applicant evaluated the results to obtain the highest scores for positive child-liking behaviors and the lowest scores for negative child-liking behaviors. Applicant surprisingly found that all three of the carrot powder products scored better than the apple powder product. Such a finding was not possible using the scale-based approach alone.

As such, using the tools of the present disclosure (i.e., a scale-based approach in combination with a behavioral checklist), Applicant was able to improve discrimination of child-liking scores of specific food products being tested. In view of the improved discrimination, the tools of the present disclosure will improve the efficiency and effectiveness of product testing, and will provide for improved product development as a result.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A tool for differentiating market research scores, the tool comprising:
a product rating scale comprising a plurality of successive scale points and a verbal anchor corresponding to each scale point; and
a behavioral list comprising a plurality of product acceptance behaviors; and
a computer and a non-transitory computer-readable medium accessible to the computer and containing a software program therein,
wherein the tool developed for administration to a non-verbal individual; and
wherein the verbal anchors describe varying degrees of liking of the product; and
wherein the software program is programmed to cause a computer processor to run a multivariate analysis of variance.

2. The tool according to claim 1, wherein the individual is a child of an age ranging from birth to about twelve months.

3. The tool according to claim 1, wherein the product is a food product.

4. (canceled)

5. The tool according to claim 1, wherein said tool is a tool for improving product development.

6. The tool according to claim 1, wherein said tool is a tool for predicting market success of a product.

7. The tool according to claim 1, wherein said tool is a tool for increasing separation of market research scores between at least two products, the tool comprising:
a product rating scale for a first product;
a product rating scale for a second product;
a behavioral list comprising a plurality of product acceptance behaviors for a first product; and
a behavioral list comprising a plurality of product acceptance behaviors for a second product.

8. The tool according to claim 7, wherein the product rating scale for the first product is the same as the product rating scale for the second product.

9. The tool according to claim 7, wherein the behavioral list for the first product is the same as the behavioral list for the second product.

10. A method for differentiating market research scores, the method comprising:
providing a product rating scale comprising a plurality of successive scale points and a verbal anchor corresponding to each scale point;
providing a behavioral list comprising a plurality of product acceptance behaviors;
instructing a consumer to evaluate a product according to the product rating scale to obtain product rating scale information;
instructing the consumer to evaluate a product according to the behavioral list to obtain behavioral information; and
applying, using a digital computer, a multivariate analysis of variance to the product rating scale information and the behavioral information;
wherein the consumer is a non-verbal individual.
